(19) United States
(12) Patent Application Publication
(10) Pub. No.: US 2026/0001275 A1
(43) Pub. Date: Jan. 1, 2026

(54) Method for Processing Thermoset Parts

(71) Applicant: Additive Manufacturing Technologies Limited, Sheffield, South Yorkshire (GB)

(72) Inventors: Joseph Crabtree, Sheffield, South Yorkshire (GB); Konstantin Rybalcenko, Sheffield, South Yorkshire (GB); Chinemelum Nedolisa, Sheffield, South Yorkshire (GB)

(21) Appl. No.: 19/128,668

(22) PCT Filed: Nov. 13, 2023
(86) PCT No.: PCT/GB2023/052960

§ 371 Date: May 9, 2025

(30) Foreign Application Priority Data
Nov. 14, 2022 (GB) 2216956.9

(51) Int. Cl. B29C 64/30; B29C 59/02; B29C 71/02; B29K 71/00; B33Y 40/20

(52) U.S. Cl. CPC B29C 64/30; B29C 71/02; B33Y 40/20; B29C 2059/027; B29K 2071/00

(57) ABSTRACT

The present disclosure relates to a method for processing an additively manufactured thermoset part. The method comprises heating an outer surface of the additively manufactured thermoset part to a temperature which is greater than or equal to the heat distortion temperature of the part and which is less than the thermal degradation temperature of the part. By pre-heating the outer surface of the part to within the aforementioned range, it has been found that the additively manufactured thermoset part can be subsequently abraded more quickly and easily.

### PRIORITY CLAIM

The present application is a U.S. National Stage patent application of International Patent Application No. PCT/GB2023/052960, filed Nov. 13, 2023, which claims priority to United Kingdom Patent Application No. 2216956.9, filed Nov. 14, 2022, the benefit of which is claimed and the disclosures of which are incorporated herein by reference in their entirety.

### FIELD

The present disclosure relates to a method for processing an additively manufactured thermoset part, and to an apparatus for performing the same.

### BACKGROUND

Additive manufacturing techniques are becoming increasingly prevalent in modern industry due to their ability to manufacture complexly shaped products in an efficient manner without significant amounts of waste. However, a potential drawback of current additive manufacturing methods is that parts made using such methods can exhibit surface defects (such as rough or castellated outer surfaces or layer lines).

Thermoplastic materials are commonly used as the build material for modern additive manufacturing techniques. Thermoplastic materials feature very minor amounts of cross-linking between polymer chains, and so adjacent polymer chains in thermoplastic materials tend to be loosely held. As such, when thermoplastic materials are exposed to a suitable solvent, the intermolecular bonds (or cross-links) between adjacent chains can be easily overcome which allows adjacent chains to move relative to one another. Because of this, thermoplastic materials can be melted and re-formed.

It is therefore common for additively manufactured thermoplastic parts to be processed via exposing the surface of the raw-state part (i.e., in the state immediately after the build operation) to one or more solvents. The one or more solvents are typically selected from groups of solvents which are suitable for overcoming the intermolecular bonds between the polymer particles which make up the material. Therefore, when the outer surface of the “raw-state” additively manufactured thermoplastic part is exposed to such a solvent, the intermolecular bonds between the particles which make up the outer surface of the “raw-state” part can be overcome which allows the particles at the surface of the part to move and re-flow. It has been found that this phenomenon can be used to reduce the surface roughness of additively manufactured thermoplastic parts.

In contrast, thermoset materials tend to exhibit very extensive amounts of cross-linking between polymer chains and therefore tend to be extremely chemically resistant. Because of this, thermoset materials are not receptive to the same chemical smoothing methods which are used for smoothing additively manufactured thermoplastic materials. Therefore, in order to remove surface defects from “raw-state” additively manufactured thermoset parts, a technician will typically need to abrade the outer surface of the part (either manually or mechanically). However, due to the extensive cross-linking between particles, this process can take up to several hours.

The aim of the present disclosure is to provide a solution to this problem by providing a method and apparatus which can more efficiently process additively manufactured thermoset parts.

### SUMMARY

A first aspect of the present disclosure provides a method for processing an additively manufactured thermoset part, the method comprising the steps of:
providing an additively manufactured thermoset part, wherein the additively manufactured thermoset part comprises a plurality of layers, wherein each layer is formed of a thermoset material, and wherein the thermoset material has a heat distortion temperature and a thermal degradation temperature;
a heating step, wherein an outer surface of the additively manufactured thermoset part is heated to a first temperature, wherein the first temperature is greater than or equal to the heat distortion temperature of the thermoset material and wherein the first temperature is less than the thermal degradation temperature of the thermoset material; and
a processing step, wherein at least part of the outer surface of the additively manufactured thermoset part, which was heated during the heating step, is abraded.

Whilst the aforementioned heating step is not capable of overcoming all the intermolecular bonds between the adjacent particles which make up the outer surface thermoset material (and so will not enable the particles to re-flow without an external influence akin to thermoplastic materials) it is believed that the aforementioned heating step is sufficient to overcome some of the intermolecular bonds between the adjacent particles of the thermoset material without causing thermal damage to the part, and hence helps to reduce the amount of cross-linking between adjacent particles at the surface of the part.

Advantageously, it has been found that by first heating the outer surface of the additively manufactured thermoset part to a temperature between its heat distortion temperature and thermal degradation temperature, the outer surface of the additively manufactured part can be more quickly and easily abraded.

In exemplary embodiments, the heating step comprises heating the outer surface of the additively manufactured thermoset part to a temperature of at least 200° C.

Advantageously, it is believed that heating the outer surface of the additively manufactured thermoset part to a temperature of at least 200° C. helps to reduce the amount of cross-linking between adjacent particles at the surface of the part, thereby allowing subsequent abrading processes to be performed more quickly and easily.

In exemplary embodiments, the heating step comprises heating the outer surface of the additively manufactured thermoset part to a temperature of at least 240° C.

Advantageously, it is believed that heating the outer surface of the additively manufactured thermoset part to a temperature of at least 240° C. helps to further reduced the amount of cross-linking between adjacent particles at the surface of the part, thereby allowing subsequent abrading processes to be performed even more quickly and easily.

In exemplary embodiments, the heating step comprises heating the outer surface of the additively manufactured thermoset part to a temperature of no more than 300° C.

Advantageously, heating the outer surface of the additively manufactured thermoset part to a temperature of no more than 300° C. helps to reduce the risk of thermal damage being caused to the additively manufactured thermoset part during the heating step.

In exemplary embodiments, the heating step comprises heating the additively manufactured thermoset part to a temperature of no more than 260° C.

Advantageously, heating the outer surface of the additively manufactured thermoset part to a temperature of no more than 260° C. helps to further reduce the risk of thermal damage being caused to the additively manufactured thermoset part during the heating step.

In exemplary embodiments, the heating step comprises heating the additively manufactured thermoset part to a temperature in the range of 200° C. to 300° C.

Advantageously, it is believed that heating the outer surface of the additively manufactured thermoset part to a temperature in the range of 200° C. to 300° C. helps to reduce the amount of cross-linking between adjacent particles at the surface of the part thereby allowing subsequent abrading processes to be performed more quickly and easily, whilst also reducing the risk of thermal damage being caused to the part.

In exemplary embodiments, the heating step comprises heating the outer surface of the additively manufactured thermoset part to a temperature in the range of 80° C. to 300° C.

In exemplary embodiments, the heating step comprises heating the outer surface of the additively manufactured thermoset part to a temperature in the range of 240° C. to 280° C.

Advantageously, it is believed that heating the outer surface of the additively manufactured thermoset part to a temperature in the range of 240° C. to 280° C. helps to further reduce the amount of cross-linking between adjacent particles at the surface of the part thereby allowing subsequent abrading processes to be performed even more quickly and easily, whilst also helping to further reduce the risk of thermal damage being caused to the additively manufactured thermoset part during the heating step.

In exemplary embodiments, the heating step comprises submerging the additively manufactured thermoset part into a liquid.

In exemplary embodiments, the heating step comprises heating the additively manufactured thermoset part whilst the additively manufactured thermoset part is submerged in the liquid.

Advantageously, it has been found that using heat to heat the outer surface of the part whilst the additively manufactured thermoset part is submerged allows subsequent abrading processes to be performed more quickly and easily than would be the case when performing the same abrading process on the same thermoset part at an ambient temperature without any form of pre-treatment.

In exemplary embodiments, the liquid has a boiling point which is equal to or greater than the heat distortion temperature of the thermoset material.

In exemplary embodiments, the outer surface of the additively manufactured thermoset part is heated to the first temperature via heating the liquid into which the additively manufactured thermoset part is submerged.

In exemplary embodiments, the liquid may be heated before the additively manufactured thermoset part has been submerged therein.

In exemplary embodiments, the liquid may be heated after the additively manufactured thermoset part has been submerged therein.

In exemplary embodiments, the liquid has a flash point which is greater than 80° C.

Advantageously, selecting a liquid having a flash point which is greater than 80° C. helps to reduce the likelihood of the liquid vaporising during processing, thereby improving the safety of the process.

In exemplary embodiments, the liquid has the formula R—COOH

In exemplary embodiments, each R is independently selected from: hydrogen, a C1 to C10 optionally substituted alkyl or a C1 to C10 optionally substituted heteroalkyl.

In exemplary embodiments, the liquid is a carboxylic acid.

In exemplary embodiments, the liquid comprises a carboxyl (COOH) functional group.

Advantageously, it is believed that liquids comprising a carboxyl functional group help to further reduce the amount of cross-linking between adjacent particles at the surface of the part and hence allow for subsequent abrading processes to be performed more quickly and easily. In exemplary embodiments, the liquid may comprise an ester.

In exemplary embodiments, the liquid may comprise Methyl 5-(dimethylamino)-2-methyl-5-oxopentanoate.

Advantageously, it has been found that using heat to heat the outer surface of the part whilst the additively manufactured thermoset part is submerged in Methyl 5-(dimethylamino)-2-methyl-5-oxopentanoate is particularly effective at reducing the processing times for epoxy thermoset materials.

In exemplary embodiments, the liquid may comprise cyclic ester.

In exemplary embodiments, the liquid may comprise a lactone.

In exemplary embodiments, the liquid may comprise γ-valerolactone.

Advantageously, since γ-valerolactone is a bio-solvent, the use of this liquid during the heating step helps to reduce the environmental impact of the claimed process.

In exemplary embodiments, the liquid may comprise a ketone.

In exemplary embodiments, the liquid may comprise a cyclic alkenone.

In exemplary embodiments, the liquid may comprise Cyrene.

In exemplary embodiments, wherein the liquid may comprise an oil.

In exemplary embodiments, the liquid may comprise a vegetable oil.

Advantageously, it has been found that using heat to heat the outer surface of the part

whilst the additively manufactured thermoset part is submerged in a vegetable oil is particularly effective at reducing the processing times for thermoset materials.

In exemplary embodiments, the liquid may comprise olive oil.

In exemplary embodiments, the liquid may comprise sunflower oil.

In exemplary embodiments, the liquid may comprise a bio-solvent.

In exemplary embodiments, the liquid may comprise ethylene glycol.

In exemplary embodiments, the additively manufactured thermoset part is removed from the liquid prior to the processing step.

In exemplary embodiments, the outer surface of the additively manufactured thermoset part comprises a defect, and the processing step comprises abrading the outer surface of the additively manufactured thermoset part so as to remove said defect.

In exemplary embodiments, the defect may be one or more layer lines.

In exemplary embodiments, the defect may be one or more castellations.

In exemplary embodiment, the defect may be an area of roughness.

In exemplary embodiments, the processing step comprises rubbing at least part of the outer surface of the additively manufactured thermoset part with a liquid detergent.

In exemplary embodiments, the processing step comprises mechanically abrading at least part of the outer surface of the additively manufactured thermoset part.

In exemplary embodiments, the processing step comprises polishing at least part of the outer surface of the additively manufactured thermoset part with abrasive materials.

In exemplary embodiments, the processing step comprises placing the additively manufactured thermoset part into a vibratory bowl containing an abrasive medium.

In exemplary embodiments, the abrasive medium comprises at least one of a foam, textile or polymer material.

In exemplary embodiments, the abrasive medium is provided as a plurality of polymeric beads.

In exemplary embodiments, the abrasive medium comprises a cotton, silk and/or linen fabric.

In exemplary embodiments, the abrasive medium comprises a polyurethane, polyethylene and/or nylon foam.

In exemplary embodiments, the processing step comprises abrading at least part of the outer surface of the additively manufactured thermoset part with the foam, textile or polymer.

In exemplary embodiments, the abrasive medium comprises acrylic thermoplastic blast media and/or polyamide nylon thermoplastic blast media.

In exemplary embodiments, the processing step comprises blasting the outer surface of the additively manufactured thermoset part with the acrylic thermoplastic blast media and/or the polyamide nylon thermoplastic blast media.

In exemplary embodiments, the abrasive medium comprises the same material as that of the additively manufactured thermoset part.

In exemplary embodiments, the abrasive medium comprises a liquid detergent.

In exemplary embodiments, the processing step comprises rubbing at least part of the outer surface of the additively manufactured thermoset part with sandpaper, optionally 400 grit sandpaper.

In exemplary embodiments, the thermoset material is a plastic-type thermoset material.

In exemplary embodiments, the thermoset materials comprises an epoxy, polyurethane, phenol, melamine or polyester based thermoset material.

In exemplary embodiments, the thermoset material is an elastomer-type thermoset material.

In exemplary embodiments, the thermoset material comprises at least one photopolymer resin material.

In exemplary embodiments, the thermoset material comprises at least one of the following materials: epoxy, polyurethane, silicone rubber, nitrile rubber, butyl rubber, styrene-butadiene rubber, natural rubber, chloroprene, polybutadiene, polyisoprene, ethylene propylene diene monomer rubber (EPDM rubber), or a fluoro-elastomer.

In exemplary embodiments, the additively manufactured thermoset part is initially provided in a hardened state.

In exemplary embodiments, the method further comprises, after the heating and processing steps, a cooling step wherein the additively manufactured thermoset part is returned to its hardened state.

Advantageously, it has been found that following the cooling step, the re-hardened additively manufactured thermoset part exhibits an improved surface finish when compared to its pre-processed raw state in much faster processing times than would be expected from conventional thermoset processing methods.

In exemplary embodiments, the cooling step may be a passive cooling step.

In exemplary embodiments, the cooling step may be an active cooling step.

In exemplary embodiments, the method further comprises, after the processing step, a drying step wherein excess liquid is removed from the outer surface of the additively manufactured thermoset part.

In exemplary embodiments, the drying step comprises heating the additively manufactured thermoset part to a temperature below the heat distortion temperature of the part.

In exemplary embodiment, the drying step comprises placing the additively manufactured thermoset part within an oven, said oven being held at a temperature in the range of 30° C. and 200° C.

In exemplary embodiment, the drying step comprises placing the additively manufactured thermoset part within a vacuum oven, said vacuum oven being held at a temperature in the range of 30° C. and 200° C. and at a pressure in the range of 1 mbar and 1000 mbar.

In exemplary embodiments, the drying step is performed before the cooling step.

In exemplary embodiments, the drying step is performed after the cooling step.

In exemplary embodiments, the method further comprises, after the processing step, a washing step wherein the additively manufactured thermoset part is rinsed with a fluid (e.g., water).

In exemplary embodiments, the washing step is performed before the cooling step.

In exemplary embodiments, the washing step is performed after the cooling step.

In exemplary embodiments, the washing step is performed in place of the cooling step.

In exemplary embodiments, the washing step is performed before the drying step.

A second aspect of the present disclosure provides an apparatus for processing an additively manufactured thermoset part, comprising:
a receptacle for receiving an additively manufactured thermoset part;
a heating apparatus configured for heating an outer surface of the additively manufactured thermoset part received within the receptacle; and
an abrading mechanism configured for abrading at least part of the outer surface of the additively manufactured thermoset part which was heated via the heating apparatus.

In exemplary embodiments, the receptacle is a liquid container.

In exemplary embodiments, the heating apparatus is configured to heat the outer surface of the additively manufactured thermoset part via heating a liquid contained within the liquid container.

In exemplary embodiments, the heating apparatus is a hot plate.

In exemplary embodiments, the abrading mechanism is a mechanical agitator.

In exemplary embodiments, the abrading mechanism and receptacle are provided as a unitary structure.

In exemplary embodiments, the receptacle is a vibratory bowl configured for receiving the additively manufactured thermoset part along with a suitable abrasive medium.

A third aspect of the present disclosure provides a method for processing an additively manufactured part comprising a Polyaryletherketone material, the method comprising the steps of:
providing an additively manufactured part, wherein the additively manufactured part comprises a plurality of layers, wherein each layer is formed of a Polyaryletherketone material, and wherein the Polyaryletherketone material has a heat distortion temperature and a thermal degradation temperature;
a heating step, wherein an outer surface of the additively manufactured part is heated to a first temperature, wherein the first temperature is greater than or equal to the heat distortion temperature of the Polyaryletherketone material and wherein the first temperature is less than the thermal degradation temperature of the Polyaryletherketone material; and
a processing step, wherein at least part of the outer surface of the additively manufactured part, which was heated during the heating step, is abraded.

Advantageously, it has been found that the aforementioned method can also be used to more quickly and easily abrade highly resistant thermoplastic materials such as PEEK or PEKK which tend to be resistant to traditional methods used for smoothing thermoplastic materials.

In exemplary embodiments, the heating step comprises heating the outer surface of the additively manufactured part to a temperature of at least 200° C.

Advantageously, it is believed that heating the outer surface of the additively manufactured part to a temperature of at least 200° C. helps to reduce the amount of cross-linking between adjacent particles at the surface of the part, thereby allowing subsequent abrading processes to be performed more quickly and easily.

In exemplary embodiments, the heating step comprises heating the outer surface of the additively manufactured part to a temperature of at least 280° C.

Advantageously, it is believed that heating the outer surface of the additively manufactured part to a temperature of at least 280° C. helps to further reduced the amount of cross-linking between adjacent particles at the surface of the part, thereby allowing subsequent abrading processes to be performed even more quickly and easily.

In exemplary embodiments, the heating step comprises heating the outer surface of the additively manufactured part to a temperature of no more than 300° C.

Advantageously, heating the outer surface of the additively manufactured part to a temperature of no more than 300° C. helps to reduce the risk of thermal damage being caused to the additively manufactured part during the heating step.

In exemplary embodiments, the heating step comprises submerging the additively manufactured part into a liquid.

In exemplary embodiments, the heating step comprises heating the additively manufactured part whilst the additively manufactured part is submerged in the liquid.

Advantageously, it has been found that using heat to heat the outer surface of the part whilst the additively manufactured part is submerged allows subsequent abrading processes to be performed more quickly and easily than would be the case when performing the same abrading process on the same part at an ambient temperature without any form of pre-treatment.

In exemplary embodiments, the liquid has a boiling point which is equal to or greater than the heat distortion temperature of the material.

In exemplary embodiments, the outer surface of the additively manufactured part is heated to the first temperature via heating the liquid into which the additively manufactured part is submerged.

In exemplary embodiments, the liquid may be heated before the additively manufactured part has been submerged therein.

In exemplary embodiments, the liquid may be heated after the additively manufactured part has been submerged therein.

In exemplary embodiments, the liquid has a flash point which is greater than 80° C.

Advantageously, selecting a liquid having a flash point which is greater than 80° C. helps to reduce the likelihood of the liquid vaporising during processing, thereby improving the safety of the process.

In exemplary embodiments, the liquid has the formula R—COOH.

In exemplary embodiments, each R is independently selected from: hydrogen, a C1 to C10 optionally substituted alkyl or a C1 to C10 optionally substituted heteroalkyl.

In exemplary embodiments, the liquid is a carboxylic acid.

In exemplary embodiments, the liquid comprises a carboxyl (COOH) functional group.

Advantageously, it is believed that liquids comprising a carboxyl functional group help to further reduce the amount of cross-linking between adjacent particles at the surface of the part and hence allow for subsequent abrading processes to be performed more quickly and easily.

In exemplary embodiments, the liquid may comprise an ester.

In exemplary embodiments, the liquid may comprise Methyl 5-(dimethylamino)-2-methyl-5-oxopentanoate.

Advantageously, it has been found that using heat to heat the outer surface of the part whilst the additively manufactured part is submerged in Methyl 5-(dimethylamino)-2-methyl-5-oxopentanoate is particularly effective at reducing the processing times for parts made from PEEK.

In exemplary embodiments, the additively manufactured part is removed from the liquid prior to the processing step.

In exemplary embodiments, the outer surface of the additively manufactured part comprises a defect, and the processing step comprises abrading the outer surface of the additively manufactured part so as to remove said defect.

In exemplary embodiments, the defect may be one or more layer lines.

In exemplary embodiments, the defect may be one or more castellations.

In exemplary embodiment, the defect may be an area of roughness.

In exemplary embodiments, the processing step comprises rubbing at least part of the outer surface of the additively manufactured part with a liquid detergent.

In exemplary embodiments, the processing step comprises mechanically abrading at least part of the outer surface of the additively manufactured part.

In exemplary embodiments, the processing step comprises polishing at least part of the outer surface of the additively manufactured part with abrasive materials.

In exemplary embodiments, the processing step comprises placing the additively manufactured part into a vibratory bowl containing an abrasive medium.

In exemplary embodiments, the abrasive medium comprises at least one of a foam, textile or polymer material.

In exemplary embodiments, the abrasive medium is provided as a plurality of polymeric beads.

In exemplary embodiments, the abrasive medium comprises a cotton, silk and/or linen fabric.

In exemplary embodiments, the abrasive medium comprises a polyurethane, polyethylene and/or nylon foam.

In exemplary embodiments, the processing step comprises abrading at least part of the outer surface of the additively manufactured part with the foam, textile or polymer material.

In exemplary embodiments, the abrasive medium comprises acrylic thermoplastic blast media and/or polyamide nylon thermoplastic blast media.

In exemplary embodiments, the processing step comprises blasting at least part of the outer surface of the additively manufactured part with the acrylic thermoplastic blast media and/or the polyamide nylon thermoplastic blast media.

In exemplary embodiments, the abrasive medium comprises the same material as that of the additively manufactured part.

In exemplary embodiments, the abrasive medium comprises a liquid detergent.

In exemplary embodiments, the processing step comprises rubbing at least part of the outer surface of the additively manufactured part with sandpaper, optionally 400 grit sandpaper.

In exemplary embodiments, the additively manufactured part may comprise Polyether Ether Ketone (PEEK) or Polyether Ketone Ketone (PEKK).

In exemplary embodiments, the additively manufactured part may comprise Polyether Ether Ketone (PEEK).

In exemplary embodiments, the additively manufactured part may comprise Polyether Ketone Ketone (PEKK).

In exemplary embodiments, the additively manufactured part is initially provided in a hardened state.

In exemplary embodiments, the method further comprises, after the heating and processing steps, a cooling step wherein the additively manufactured part is returned to its hardened state.

Advantageously, it has been found that following the cooling step, the re-hardened additively manufactured part exhibits an improved surface finish when compared to its pre-processed raw state in much faster processing times than would be expected from conventional processing methods.

In exemplary embodiments, the cooling step may be a passive cooling step.

In exemplary embodiments, the cooling step may be an active cooling step.

In exemplary embodiments, the method further comprises, after the processing step, a drying step wherein excess liquid is removed from the outer surface of the additively manufactured part.

In exemplary embodiments, the drying step comprises heating the additively manufactured part to a temperature below the heat distortion temperature of the part.

In exemplary embodiment, the drying step comprises placing the additively manufactured part within an oven, said oven being held at a temperature in the range of 30° C. and 200° C.

In exemplary embodiment, the drying step comprises placing the additively manufactured part within a vacuum oven, said vacuum oven being held at a temperature in the range of 30° C. and 200° C. and at a pressure in the range of 1 mbar and 1000 mbar.

In exemplary embodiments, the drying step is performed before the cooling step.

In exemplary embodiments, the drying step is performed after the cooling step.

In exemplary embodiments, the method further comprises, after the processing step, a washing step wherein the additively manufactured part is rinsed with a fluid (e.g., water).

In exemplary embodiments, the washing step is performed before the cooling step.

In exemplary embodiments, the washing step is performed after the cooling step.

In exemplary embodiments, the washing step is performed in place of the cooling step.

In exemplary embodiments, the washing step is performed before the drying step.

We consider the term “thermoset material” to mean a polymeric material wherein the intermolecular bonds (or cross-links) between adjacent polymer chains are sufficiently strong so as to prevent the material from being melted and re-formed.

We consider the term “cross-link” to mean an intermolecular bond such as a hydrogen bond or a van der Waal's attractive force between adjacent particles.

We consider the term “heat distortion temperature” to mean the temperature at which the intermolecular bonds between adjacent particles may start to be overcome.

We consider the term “heat degradation temperature” to mean the temperature at which an external surface of a polymer part will begin the burn, char or become otherwise thermally degraded.

We consider the term “vegetable oil” to mean an oil which can be extracted from the seeds, fruits or from other parts of a plant.

We consider the term “bio-solvent” to mean a solvent which can be derived from the processing of agricultural crops.

### BRIEF DESCRIPTION OF THE DRAWINGS

Examples of the present disclosure will now be described with reference to the accompanying drawings, in which:

FIG. 1 is a flow diagram illustrating a method of processing an additively manufactured thermoset part;

FIG. 2a is a perspective view of a first part of an apparatus for performing the method illustrated in FIG. 1;

FIG. 2b is a perspective view of a second part of an apparatus for performing the method illustrated in FIG. 1;

FIG. 3a is a perspective view of an alternative apparatus for performing the method illustrated in FIG. 1;

FIG. 3b is another perspective view of the apparatus illustrated in FIG. 3a;

FIG. 4a is an image of a “raw-state” thermoset polyurethane elastomer sample before being processed;

FIG. 4b is an image of a thermoset polyurethane elastomer sample after being processed using one method according to the present disclosure;

FIG. 4c is an image of a thermoset polyurethane elastomer sample after being processed using another method according to the present disclosure;

FIG. 4d is an image of a thermoset polyurethane elastomer sample after being processed using yet another method according to the present disclosure;

FIG. 4e is an image of a thermoset polyurethane elastomer sample after being processed using a further method according to the present disclosure;

FIG. 4f is an image of a thermoset polyurethane elastomer sample after being processed using a further method according to the present disclosure;

FIG. 5a is an image of another “raw-state” thermoset epoxy sample before being processed;

FIG. 5b is an image of the thermoset epoxy sample after being processed using one method according to the present disclosure;

FIG. 6a is an image of a “raw-state” thermoplastic PEEK sample before being processed; and

FIG. 6b is an image of the thermoplastic PEEK sample after being processed using one method according to the present disclosure.

### DETAILED DESCRIPTION

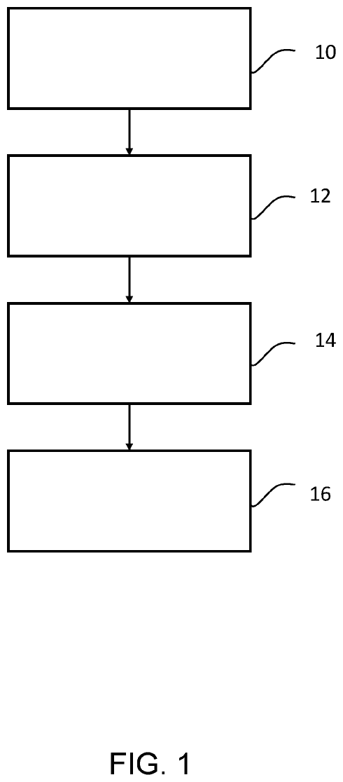

FIG. 1 shows a schematic representation of an exemplary method for processing an additively manufactured thermoset part according to an aspect of the present disclosure.

Before the method is described, it is important to note that during additive manufacturing processes, such as Stereolithography, a laser or other energy emitting device solidifies a desired shape on a first layer of polymer build material. The first layer of build material is then lifted by a build platform to allow for a second layer to be filled with liquid polymer which is then subsequently solidified via the energy emitting device. Subsequent layers are then applied and solidified in the same fashion thereafter. As such, parts obtained via an additive manufacturing process tend to exhibit a plurality of layers.

It has been found that the material at any surface of the additively manufactured part may often exhibit a different, less favourable structure to that of the material which is beneath said surface. As such, the presence of less favourable structures at the surface of a given part can result in additively manufactured parts having a rough surface finish. The outer surface of additively manufactured parts may also include other forms of defect such as castellations or layer lines. It is therefore typically desirable for such surfaces to be removed, polished or smoothed to provide the additively manufactured part with an improved surface finish. It may also be desirable to remove the layered structure of a part to improve the optical properties (e.g., translucency) of the part.

As set out above within the background section, polymeric materials exhibit various levels of cross-linking between the polymer chains which make up the material. “Cross-links” are a type of intermolecular bond which may be present between adjacent particles which make up a given material. Intermolecular bonds (or “cross-links”) are typically provided in the form of hydrogen bonds or Van der Waal's attractive forces between adjacent particles but may also be provided in other forms.

Thermoplastic materials tend to feature very minor amounts of cross-linking between polymer chains, and so adjacent polymer chains in thermoplastic materials tend to be loosely held. As such, when thermoplastic materials are exposed to a suitable solvent, the intermolecular bonds (or cross-links) between adjacent chains can be easily overcome which allows adjacent chains to move relative to one another.

It is therefore common for the surface of “raw-state” additively manufactured thermoplastic parts (i.e., in the state immediately after the build operation) to be processed via exposing the surface of the raw-state part to one or more solvents. The one or more solvents are typically selected from groups of solvents which are suitable for overcoming the intermolecular bonds between the polymer particles which make up the material. Therefore, when the outer surface of the “raw-state” additively manufactured thermoplastic part is exposed to such a solvent, the intermolecular bonds between the particles which make up the outer surface of the “raw-state” part can be overcome which allows the particles at the surface of the part move and re-flow. It has been found that this phenomenon can be used to reduce the surface roughness of additively manufactured thermoplastic parts.

Conversely, thermoset materials tend to exhibit very extensive amounts of cross-linking between polymer chains and so are not receptive to the same processes used for thermoplastic materials.

Therefore, in order to remove surface defects from “raw-state” additively manufactured thermoset parts, a technician will typically need to abrade the outer surface of the part (either manually or mechanically) which can take up to several hours due to the extensive cross-linking between the particles which make up the outer surface of the thermoset part. The present disclosure aims to provide a solution to this problem.

At a first step 10 of the method, the raw-state additively manufactured part is provided (i.e., in the state that it was immediately after the build operation) which comprises a thermoset material. In some examples, the method may comprise a manufacturing step in which the part is additively manufactured using a thermoset build material. However, it shall be appreciated that in other examples, a pre-built additively manufactured thermoset part may be provided and hence in some examples, such a manufacturing step may be omitted from the claimed method.

The present disclosure is primarily concerned with the processing of thermoset materials, which shall be defined herein as a group of polymeric materials wherein the intermolecular bonds (or cross-links) between adjacent polymer chains are sufficiently strong so as to prevent the material from being melted and re-formed. However, it has also been found that the presently disclosed method can be used to process high-performance thermoplastic materials (such as PEEK or PEKK) which cannot be otherwise processed via the methods which are typically used for thermoplastic materials.

The thermoset material may be a plastic-type thermoset material or may be an elastomer-type thermoset material.

Examples of suitable plastic-type thermoset materials include, but are not limited to, epoxy, polyurethane, phenol, melamine and/or polyester based thermoset materials.

Examples of suitable elastomer-type thermoset materials include, but are not limited to, polyurethane, silicone rubber, nitrile rubber, butyl rubber, styrene-butadiene rubber, natural rubber, chloroprene, polybutadiene, polyisoprene, ethylene propylene diene monomer rubber (EPDM rubber), and/or fluoro-elastomers.

All thermoset materials feature a Heat Distortion Temperature and a Thermal Degradation Temperature, which are also influenced by the strength of the intermolecular bonds between the adjacent polymer chains (or particles) which make up the material.

The “Heat Distortion Temperature” of a material is defined as the temperature at which the intermolecular bonds between adjacent particles may start to be overcome, and hence defines the temperature at which movement between some of the polymer chains which make up the material can be observed.

It shall be appreciated by the skilled person that the “Heat Distortion Temperature” of a material can be obtained via reviewing relevant scientific data and/or look-up tables in which the “Heat Distortion Temperature” for a range of material types will typically be provided. Should this data be unavailable for a given material type, the Heat Distortion Temperature of a material can also be obtained empirically without undue burden by following the test procedure outlined in ASTM D648.

Meanwhile, the “Thermal Degradation Temperature” of a material is defined as the temperature at which an external surface of a polymer part will begin to burn, char, or become otherwise thermally degraded. In other words, the “Thermal Degradation Temperature” is the maximum temperature to which a material can be heated before it starts to degrade.

As with the “Heat Distortion Temperature”, it shall be appreciated by the skilled person that the “Thermal Degradation Temperature” of a material can be obtained via reviewing relevant scientific data and/or look-up tables in which the “Thermal Degradation temperature” for a range of material types will typically be provided. Should this data be unavailable for a given material type, the Thermal Degradation Temperature of a material can also be obtained empirically without undue burden via subjecting a given material to a controlled heating and noting the temperature at which the material starts to burn or char.

For most thermoset materials, their respective Heat Distortion Temperature and Thermal Degradation Temperature will fall somewhere between 200° C. and 300° C., although it shall be appreciated that for some thermoset materials the Heat Distortion Temperature and/or Thermal Degradation Temperature may fall outside of this range.

Following step 10, an outer surface of the additively manufactured thermoset part is heated during step 12 to a temperature which is greater than the heat distortion temperature of the material but less than the thermal degradation temperature of the material.

Whilst the aforementioned heating step is not capable of overcoming all the intermolecular bonds between the adjacent particles of the thermoset material (and so will not enable the particles to re-flow without an external influence akin to thermoplastic materials) it is believed that heating the outer surface of the part to a temperature between the heat distortion temperature and thermal degradation temperature of the material can help to overcome some of the intermolecular bonds between the adjacent particles which make up the outer surface thermoset material without causing thermal damage to the part.

It is been found that since the particles at the outer surface of the part are not as extensively cross-linked (and hence are not held together quite as tightly) following such a heating step, less energy is subsequently required to abrade away said particles from the outer surface and hence processing can be performed more quickly and easily.

It shall be appreciated that for some thermoset materials, the aforementioned heating step may cause the outer surface of the additively manufactured thermoset part to soften (or become “sticky” or “tacky”). However, for other thermoset materials, there may be no visible change to the outer surface of the additively manufactured thermoset part following the heating step.

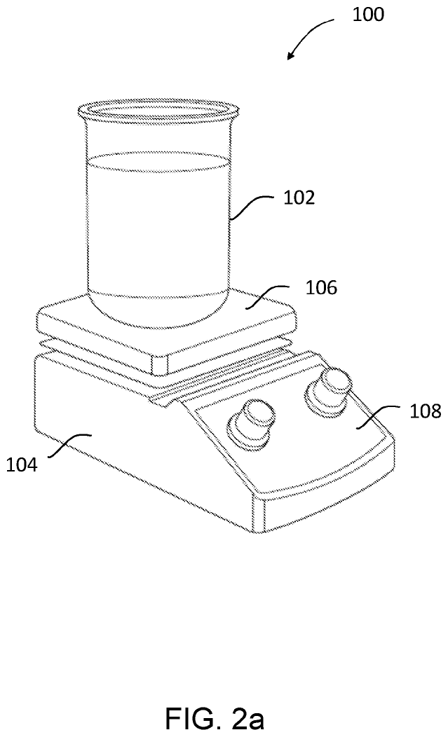

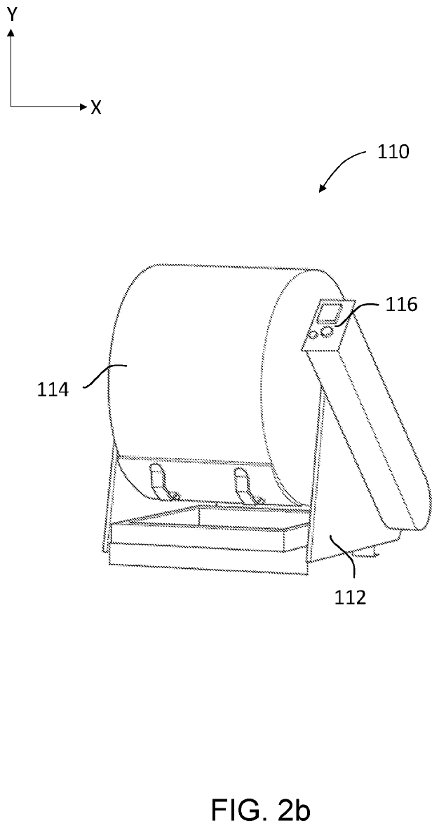

In some examples, the additively manufactured thermoset part may be heated indirectly via submerging the additively manufactured thermoset part into a heated liquid bath. An apparatus suitable for performing such a method is shown in FIG. 2a.

The apparatus 100 comprises a receptacle 102 for receiving an additively manufactured part (not shown) and a heating element 104 which is operatively coupled to the receptacle 102. In the example illustrated in FIG. 2a, the receptacle 102 is provided in the form of a glass beaker but in other examples may comprise any form of liquid container suitable for holding a heated liquid.

The liquid into which the additively manufactured thermoset part is submerged is selected from a group of liquids having a boiling point which equal to or greater than the heat distortion temperature of the additively manufactured thermoset part. It is not possible to process additively manufactured parts with liquids having a boiling point which is less than the heat distortion temperature of the part since, upon heating, such liquids do not reach a temperature which is suitable to overcome the intermolecular bonds of the thermoset material. It is also beneficial to select a liquid having a flash point which is greater than 80° C. to help prevent the liquid from vaporizing or combusting during processing.

Examples of liquids which are suitable for use with the claimed method include, but are not limited to, liquid esters, such as Methyl 5-(dimethylamino)-2-methyl-5-oxopentanoate and γ-valerolactone, liquid ketones, such as cyrene, and/or cooking oils, such as vegetable oil, olive oil or sunflower oil. The aforementioned liquids are advantageous since they are bio-solvents and hence can be derived from the processing of agricultural crops. However, it shall be appreciated that in some examples, other liquids may be used. It has also been found that beneficial results can be achieved when using vegetable oils or liquids having a carboxyl (COOH) functional group.

Once a suitable liquid has been selected and transferred into the receptacle, said liquid is heated to a temperature which is equal to or greater than the Heat Distortion Temperature of the additively manufactured thermoset part and which is less than the Thermal Degradation Temperature of the additively manufactured thermoset part. As set out above, for most thermoset materials, the Heat Distortion Temperature and Thermal Degradation Temperature will fall somewhere between 200° C. and 300° C., and so the liquid will typically be heated until it reaches a temperature between 200° C. and 300° C., although it shall be appreciated that in some examples the liquid may be heated to a temperature outside of these ranges.

In the apparatus 100 illustrated in FIG. 2a, the heating element 104 is provided in the form of a hot plate having a heat-able upper surface 106 onto which the receptacle 102 is received. The hot plate also comprises an associated control panel 108 which can be controlled by a user to increase or decrease the amount of thermal energy being applied to the receptacle 102 (and hence the heat of the liquid contained therein). However, it shall be appreciated that in other examples, other forms of heating element may be used.

The additively manufactured thermoset part may be placed within the receptacle 102 before or after the liquid has been heated. For example, in some embodiments of the present disclosure the liquid may be brought to the desired temperature and then the additively manufactured thermoset part may be submerged within the liquid. In other embodiments, the additively manufactured thermoset part may be first submerged within the liquid and then the liquid may then be subsequently heated to the desired temperature.

The part is then left within the heated liquid for a period of time. In some examples, the thermoset part may remain submerged until the outer surface of the part becomes soft and tacky. In other examples, the additively manufactured part may be left for a pre-determined exposure time. In most examples, the additively manufactured part is left for an exposure time between 5 and 10 seconds, although it shall be appreciated that in some examples exposure times in the range of 1 second to 1 hour may be used.

Advantageously, it has been found that using heat to heat the outer surface of the part whilst the additively manufactured part is submerged allows subsequent abrading processes to be performed more quickly and easily than would be the case when performing the same abrading process on the same part at an ambient temperature without any form of pre-treatment.

It has also been found that heating the part indirectly via a liquid bath helps to reduce the risk of the outer surface of the part burning or charring during the heating step 12. Heating parts via liquid immersion also ensures temperature uniformity across the part.

However, it shall also be appreciated that in some examples, the additively manufactured thermoset part may be heated directly (i.e., without submerging the part in a liquid) via radiation, convection and/or conduction. In some examples, the additively manufactured part may be left in a hot oven until the outer surface of the part reaches a desired temperature. In other examples, hot vapors or gasses may be directed onto the outer surface of the part until the desired temperature has been achieved. Furthermore, in some examples, the part may be heated via contact with high temperature materials, such as heated metals.

Following the heating step 12, the additively manufactured thermoset part is removed from the liquid. The additively manufactured thermoset part is then abraded during processing step 14 to remove at least some of the outer surface of the part. The processing step may be performed mechanically using a suitable abrading mechanism or in some examples may be performed manually.

A suitable abrading mechanism 110 is illustrated in FIG. 2b. The abrading mechanism 110 illustrated in FIG. 2b is provided separately from the receptacle 102 and heating element 104 illustrated in FIG. 2a.

In the example illustrated in FIG. 2b, the abrading mechanism 110 comprises base 112 and a processing chamber 114 which is rotatably coupled to the base 112. In the illustrated example, the processing chamber 114 is provided as a rotary drum but in other examples a different form of processing chamber may be used. In the illustrated example, the processing chamber 114 is orientated substantially horizontally such that the axis of rotation of the rotary drum is substantially parallel to the horizontal (X) axis. However, it shall be appreciated that in some examples, the processing chamber 114 may be oriented vertically or at any other suitable angle.

An actuator (e.g., an electric motor) is also provided for driving the processing chamber about its axis of rotation. The actuator (not shown) is coupled to a corresponding controller 116 to enable a user to increase or decrease the speed of rotation of the rotary drum.

During the processing step 14, the additively manufactured thermoset part is placed within the abrading mechanism 110 (in the case of FIG. 2b within the processing chamber 114) along with a suitable abrasive medium. In some examples, the abrasive medium may be provided in the form of soft polymeric beads. Examples of suitable abrasive mediums include acrylic thermoplastic blast media and polyamide nylon thermoplastic blast media.

In other examples, different abrasive mediums (such as soft/flexible foams or soft fabrics) may instead be used. Examples of alternative abrasive mediums include cotton, silk and linen fabrics and polyurethane, polyethylene and nylon foams.

As the abrading mechanism 110 is activated and the rotary drum starts to rotate, the abrasive medium provided within the processing chamber 114 will start to contact and abrade the outer surface of the additively manufactured thermoset part, thereby causing said surface to be removed from the part.

Advantageously, it has been found that following the claimed method, surface defects can be abraded from the outer surface of an additively manufactured thermoset part in approximately 5 minutes. By comparison, using current methods (wherein the part is not heated prior to abrading) it would take an operator multiple hours to achieve comparable results.

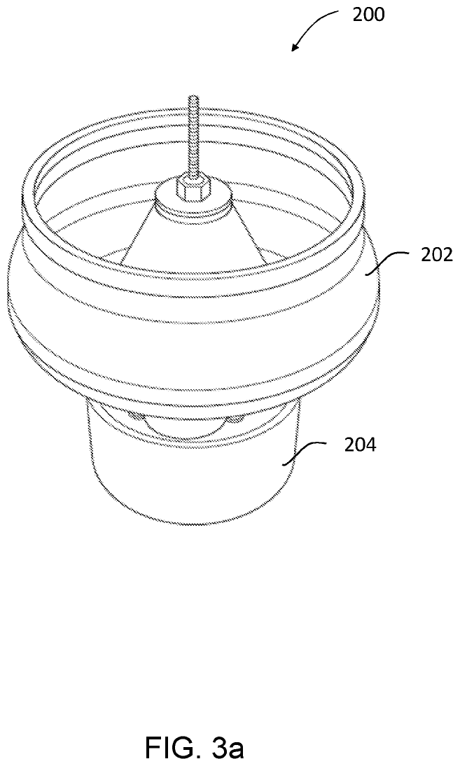

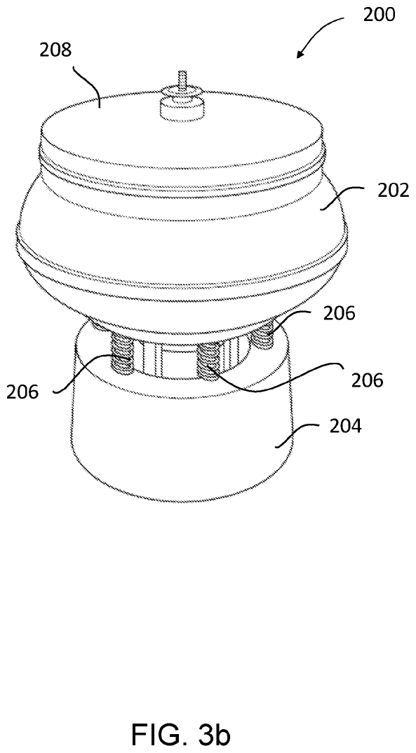

An alternative apparatus 200 suitable for processing an additively manufactured thermoset part is illustrated in FIG. 3 in which the receptacle 302 and abrading mechanism 310 are provided as a single, unitary structure.

As with the apparatus 100 illustrated in FIG. 2, the apparatus 200 comprises a receptacle 202 suitable for receiving an additively manufactured part and a corresponding liquid as may be required during the heating step 12. However, in the example illustrated in FIG. 3, the receptacle 202 is supported on a vibratory base 204 such that the receptacle 202 can also be used as the abrading mechanism during the processing step 14.

In the illustrated example, the receptacle 202 is provided in the form of a bowl which is manufactured from a polymeric rubber material, although other suitable materials may be used. The receptacle 202 may also be provided with a lid 208 (as shown in FIG. 2b) to help reduce the occurrence of unwanted spillages.

The receptacle 202 is mounted on the vibratory base 204 via a series of coil springs 206 which permit vertical and horizontal movement of the receptacle 202 relative to the base 204. However, it shall be appreciated that in other examples, alternative forms of mounting may be used.

A piezoelectric actuator (not shown) is also provided within the base 204. Upon activation, the vibrations generated by the piezoelectric actuator are transferred onto the receptacle 202 via the coil springs 206 thereby causing the receptacle 202 to vibrate at the same or similar frequency to that of the piezoelectric actuator. An associated controller (not shown) may also be provided which is configured to enable a user to control the vibrational frequency of the piezoelectric actuator (and hence the frequency of the vibrations which are applied to the receptacle).

A heating element (not shown) may also be provided within the base 204 to enable the receptacle 202 (and liquid contained therein) to be heated as necessary during the heating step 12. However, it shall be appreciated that in other examples, one or more heating element(s) may be integrated into the walls of the receptacle or may be provided as a separate element.

It shall also be appreciated that in some examples, alternative methods for abrading the additively manufactured thermoset part may be used which may include, but are not limited to, blasting the outer surface of the part with a pressurised stream of air, water or a mixture of steam and abrasive media which are directed onto the surface of the part.

When the processing step is performed using a pressurized stream of air, water or a mixture of steam and abrasive media, the air, water or steam will typically be pressurized to a pressure of between 1 bar and 9 bar, and in some instances to a pressure of between 4 bar to 7 bar.

The abrasive media may be made from plastic, ceramic or glass material. The abrasive media may be sized between 4 microns up to 1000 microns. However, the optimal size range for the abrasive media has been found to be between 106 microns and 212 microns. The hardness of the abrasive media may also vary from 1 Mohs to 10 Mohs, although optimal processing is achieved with abrasive media having a hardness of approximately 5 Mohs.

Once the processing step 14 has been performed, the outer surface of the additively manufactured thermoset part is allowed cool during step 16 thereby returning the additively manufactured thermoset part back to a hardened state. Advantageously, it has been found that the re-hardened part features an improved surface than when it was in its pre-processed “raw state”. It has also been found that the aforementioned method can achieve an improved surface finish in much faster processing times than traditional methods used to process thermoset parts.

In some examples, the additively manufactured part may be allowed to cool naturally to room temperature without any external cooling sources being applied thereto. However, in other examples, the part may be actively cooled (for example via placing the part into a refrigeration unit or freezer or by blasting or immersing the part in a cool fluid).

Furthermore, in some examples, the additively manufactured part may be subjected to a washing and/or a drying step to remove excess liquid which may still be present on the part following the heating step 12 (although it shall be appreciated that in some examples these steps may be omitted).

The washing step may be performed before or after the cooling step and involves rinsing the additively manufactured thermoset part with a fluid. Water is typically used to rinse any excess liquid from the part. However, it shall be appreciated that in some examples, another suitable fluid may be used.

The drying step may also be performed before or after the cooling step (but always after the washing step) and involves heating the additively manufactured part to a temperature below the heat distortion temperature of the part.

In some examples, the additively manufactured part may be placed in an oven held at a temperature between 30° C. and 200° C. In other examples, the drying step may be performed via placing the part within a vacuum oven held at a temperature between 30° C. and 200° C. and at a pressure between 1 mbar and 1000 mbar. It shall also be appreciated that in other examples, the drying step may be performed using any other suitable heat emitting device.

Although the invention has been described above with reference to one or more preferred examples, it will be appreciated that various changes or modifications may be made without departing from the scope of the disclosure as defined in the appended claims.

### EXPERIMENTAL EXAMPLES

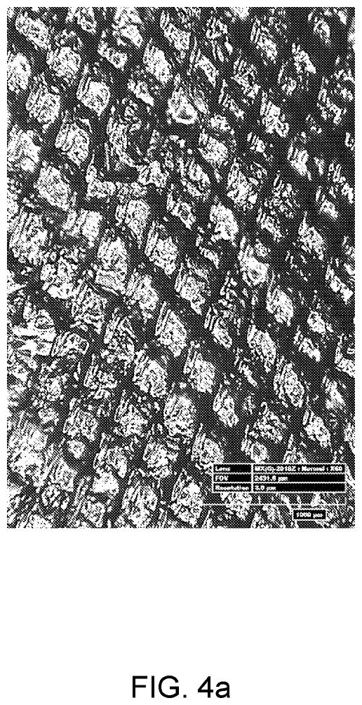

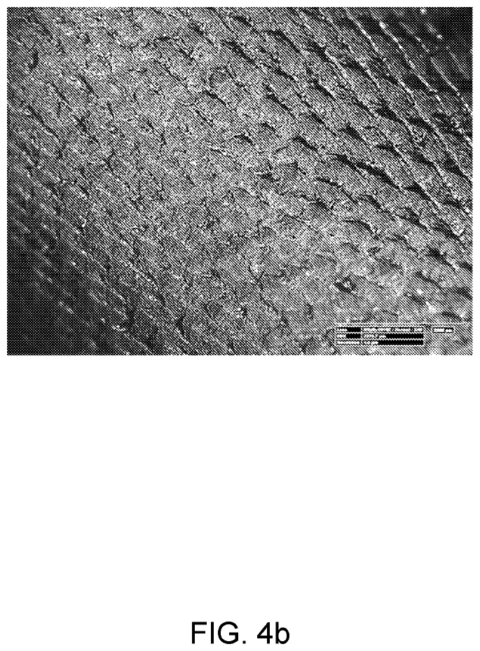

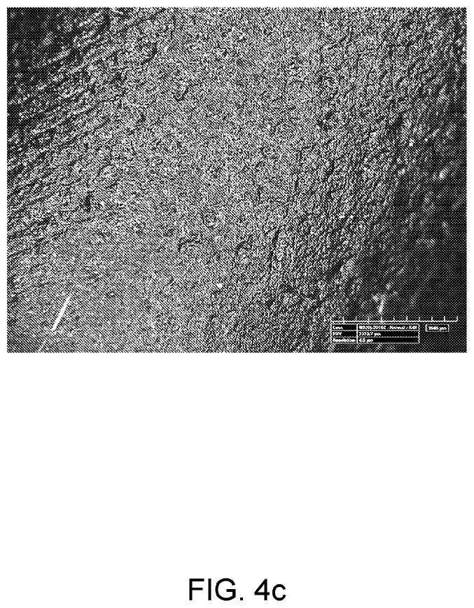

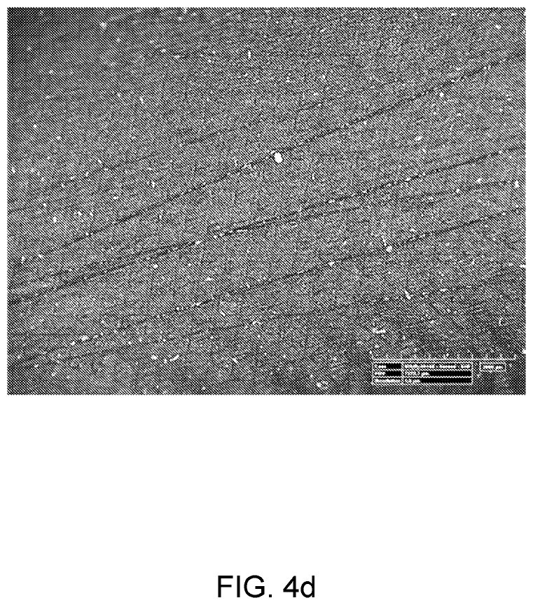

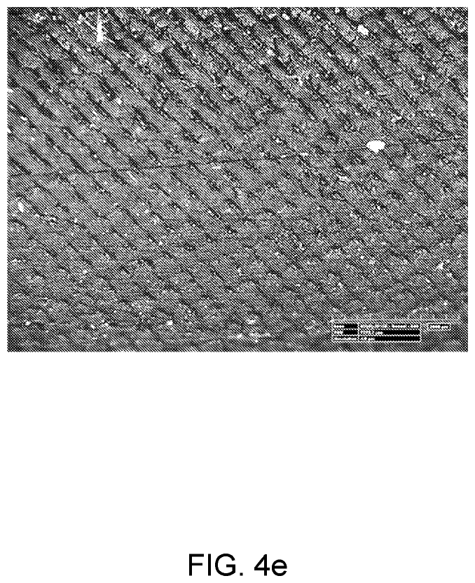

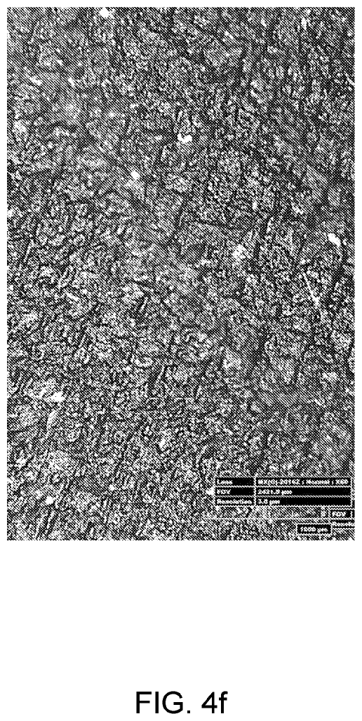

Images of samples of a thermoset polyurethane elastomer which have been processed using methods according to the present disclosure are illustrated in FIGS. 4a to 4f.

The image provided in FIG. 4a is an unprocessed sample of a thermoset polyurethane elastomer.

The image provided in FIG. 4b is a sample of the same thermoset polyurethane elastomer material which has been processed according to the method of the claimed disclosure under the following conditions:
Liquid type—γ-valerolactone
Heating temperature—220° C.
Exposure time—5 to 10 seconds

The γ-valerolactone solvent was poured into a beaker and heated to 220° C. The test sample was dipped into the heated solvent for 5-10 seconds. The test sample was then taken out of the solvent several times and rubbed softly using a soft/flexible polyurethane foam. Observations were made on the test sample during the rubbing process to ensure that the desired smoothing level was reached.

The image provided in FIG. 4c is a sample of a thermoset polyurethane elastomer material which has been processed according to the method of the claimed disclosure under the following conditions:
Liquid type—Cyrene/γ-valerolactone mixture
Heating temperature—240° C.
Exposure time—5 to 10 seconds

The solvent mixture was poured into a beaker and heated to 240° C., test sample was dipped into the heated solvent for 5-10 seconds, the test sample was then taken out of the solvent several times and rubbed softly using a soft/flexible polyurethane foam for approximately 5 minutes. Observations were made on the test sample during the rubbing process to ensure that the desired smoothing level was reached.

The image provided in FIG. 4d is a sample of a thermoset polyurethane elastomer material which has been processed according to the method of the claimed disclosure under the following conditions:
Liquid type—Sunflower oil
Heating temperature—260° C.
Exposure time—5 to 10 seconds

Sunflower oil was poured into a beaker. Sunflower oil was heated to 260° C., test sample was dipped into the heated oil for 5-10 seconds, the test sample was then taken out of the oil several times and rubbed softly using a soft/flexible polyurethane foam for approximately 5 minutes. Observations were made on the test sample during the rubbing process to ensure that the desired smoothing level was reached.

The image provided in FIG. 4e is a sample of a thermoset polyurethane elastomer material which has been processed according to the method of the claimed disclosure under the following conditions:
Liquid type—Olive oil
Heating temperature—260° C.
Exposure time—5 to 10 seconds

Olive oil was poured into a beaker. Olive oil was heated to 260° C., test sample was dipped into the heated oil for 5-10 seconds, the test sample was then taken out of the oil several times and rubbed softly using a soft/flexible polyurethane foam for approximately 5 minutes. Observations were made on the test sample during the rubbing process to ensure that the desired smoothing level was reached.

The image provided in FIG. 4f is a sample of a thermoset polyurethane elastomer material which has been processed according to the method of the claimed disclosure under the following conditions:
Liquid type—Methyl 5-(dimethylamino)-2-methyl-5-oxopentanoate
Heating temperature—250° C.
Exposure time—5 to 10 seconds

The Methyl 5-(dimethylamino)-2-methyl-5-oxopentanoate solvent was poured into a beaker and heated to 250° C. The test sample was dipped into the heated solvent for 5-10 seconds. The test sample was then taken out of the solvent several times and rubbed softly using a soft/flexible polyurethane foam for approximately 5 minutes. Observations were made on the test sample during the rubbing process to ensure that the desired smoothing level was reached.

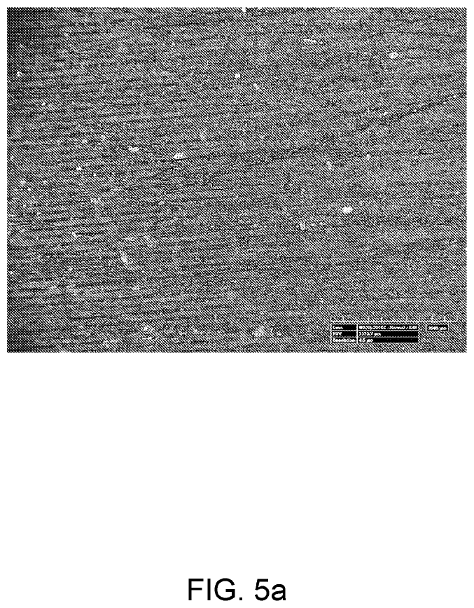

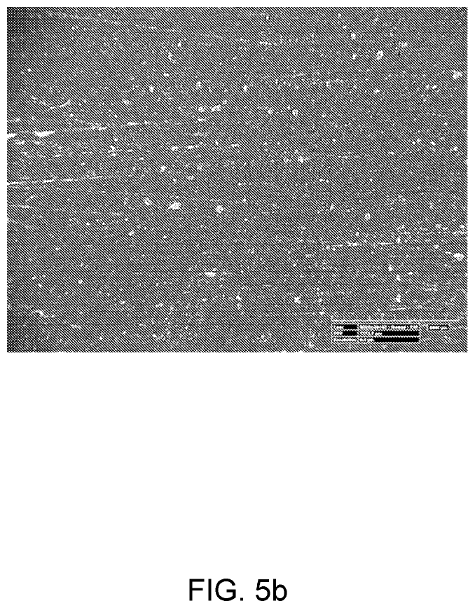

Images of a sample of thermoset epoxy material which has been processed using methods according to the present disclosure are illustrated in FIGS. 5a and 5b.

The image provided in FIG. 5a is an unprocessed sample of thermoset epoxy material.

The image provided in FIG. 5b is a sample of a thermoset epoxy material which has been processed according to the method of the claimed disclosure under the following conditions:
Liquid type—Methyl 5-(dimethylamino)-2-methyl-5-oxopentanoate
Heating temperature—280° C.
Exposure time—5 to 10 seconds

Methyl 5-(dimethylamino)-2-methyl-5-oxopentanoate was poured into a beaker. Methyl 5-(dimethylamino)-2-methyl-5-oxopentanoate was heated to 280° C., test sample was dipped into the heated solvent for 5-10 seconds, the test sample was then taken out of the solvent several times and abraded manually on a super-fine sandpaper of 400 grit for approximately 5 minutes. Observations were made on the test sample during the abrading process to ensure that the desired smoothing level is reached.

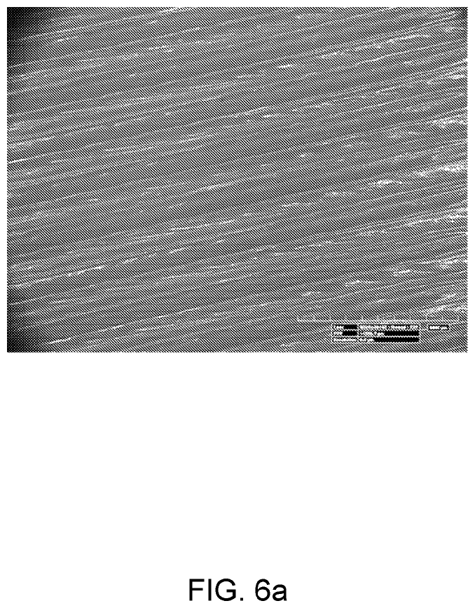

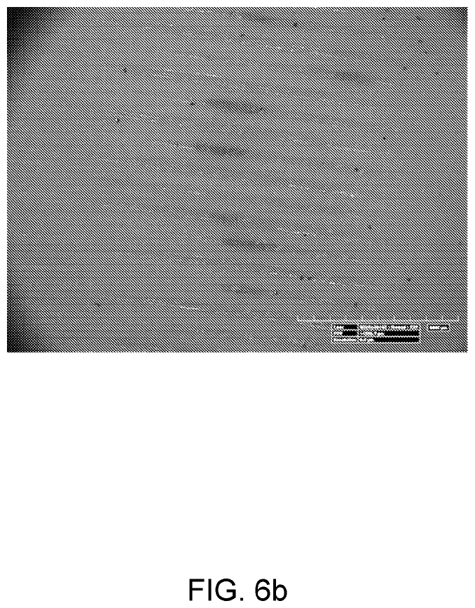

Images of a sample of thermoplastic polyether ether ketone (PEEK) which has been processed using methods according to the present disclosure are illustrated in FIGS. 6a and 6b.

The image provided in FIG. 6a is an unprocessed sample of thermoplastic PEEK material.

The image provided in FIG. 6b is a sample of the thermoplastic PEEK material which has been processed according to the method of the claimed disclosure under the following conditions:
Liquid type—Methyl 5-(dimethylamino)-2-methyl-5-oxopentanoate
Heating temperature—280° C.
Exposure time—5 to 10 seconds

Methyl 5-(dimethylamino)-2-methyl-5-oxopentanoate was poured into a beaker. Methyl 5-(dimethylamino)-2-methyl-5-oxopentanoate was heated to 280° C., test sample was dipped into the heated solvent for 5-10 seconds, the test sample was then taken out of the solvent several times and abraded manually on a super-fine sandpaper of 400 grit for approximately 5 minutes. Observations were made on the test sample during the abrading process to ensure that the desired smoothing level is reached.

1. A method for processing an additively manufactured thermoset part, the method comprising the steps of:
providing an additively manufactured thermoset part, wherein the additively manufactured thermoset part comprises a plurality of layers, wherein each layer is formed of a thermoset material, and wherein the thermoset material has a heat distortion temperature and a thermal degradation temperature;
a heating step, wherein an outer surface of the additively manufactured thermoset part is heated to a first temperature, wherein the first temperature is greater than or equal to the heat distortion temperature of the thermoset material and wherein the first temperature is less than the thermal degradation temperature of the thermoset material; and
a processing step, wherein at least part of the outer surface of the additively manufactured thermoset part, which was heated during the heating step, is abraded.

2. The method according to claim 1, wherein the heating step comprises heating the outer surface of the additively manufactured thermoset part to a temperature of at least 200° C., and optionally to a temperature of at least 240° C.

3. The method according to claim 1, wherein the heating step comprises heating the outer surface of the additively manufactured thermoset part to a temperature of no more than 300° C., and optionally to a temperature of no more than 260° C.

4. The method according to claim 1, wherein the heating step comprises submerging the additively manufactured thermoset part into a liquid having a boiling point which is equal to or greater than the heat distortion temperature of the thermoset material and heating the additively manufactured thermoset part whilst the additively manufactured thermoset part is submerged in said liquid.

5. The method according to claim 4, wherein the liquid has a flash point which is greater than 80° C.

6. The method according to claim 4, wherein the liquid comprises a carboxyl (COOH) functional group.

7. The method according to claim 4, wherein the liquid comprises an ester, optionally Methyl 5-(dimethylamino)-2-methyl-5-oxopentanoate.

8. The method according to claim 7, wherein the liquid comprises a cyclic ester, optionally a lactone, and most optionally γ-valerolactone.

9. The method according to claim 1, wherein the outer surface of the additively manufactured thermoset part comprises a defect, and wherein the processing step comprises abrading the outer surface of the additively manufactured thermoset part so as to remove said defect.

10. An apparatus for processing an additively manufactured thermoset part, comprising:
a receptacle for receiving an additively manufactured thermoset part;
a heating apparatus configured for heating an outer surface of the additively manufactured thermoset part received within the receptacle; and
an abrading mechanism configured for abrading at least part of the outer surface of the additively manufactured thermoset part which was heated via the heating apparatus.

11. The apparatus according to claim 10, wherein the receptacle is a liquid container, and wherein the heating apparatus is configured to heat the outer surface of the additively manufactured thermoset part via heating a liquid contained within the liquid container.

12. The apparatus according to claim 10, wherein the abrading mechanism is a mechanical agitator.

13. The apparatus according to claim 10, wherein the abrading mechanism and receptacle are provided as a unitary structure, and optionally wherein the receptacle is a vibratory bowl configured for receiving the additively manufactured thermoset part along with a suitable abrasive medium.

14. A method for processing an additively manufactured part comprising a Polyaryletherketone material, the method comprising the steps of:
providing an additively manufactured part, wherein the additively manufactured part comprises a plurality of layers, wherein each layer is formed of a Polyaryletherketone material, and wherein the Polyaryletherketone material has a heat distortion temperature and a thermal degradation temperature;
a heating step, wherein an outer surface of the additively manufactured part is heated to a first temperature, wherein the first temperature is greater than or equal to the heat distortion temperature of the Polyaryletherketone material and wherein the first temperature is less than the thermal degradation temperature of the Polyaryletherketone material; and
a processing step, wherein at least part of the outer surface of the additively manufactured part, which was heated during the heating step, is abraded.

15. The method according to claim 14, wherein the Polyaryletherketone material is Polyether Ether Ketone (PEEK) or Polyether Ketone Ketone (PEKK).

16. The method according to claim 14, wherein the heating step comprises submerging the additively manufactured part into a liquid having a boiling point which is equal to or greater than the heat distortion temperature of the Polyaryletherketone material, and heating the additively manufactured part whilst the additively manufactured part is submerged in said liquid.

17. The method according to claim 14, wherein the liquid comprises a carboxyl (COOH) functional group.

18. The method according to claim 14, wherein the liquid comprises an ester, optionally Methyl 5-(dimethylamino)-2-methyl-5-oxopentanoate.

19. The method according to claim 14, wherein the heating step comprises heating the outer surface of the additively manufactured part to a temperature of at least 200° C., and optionally to a temperature of at least 280° C.

20. The method according to claim 14, wherein the heating step comprises heating the outer surface of the additively manufactured part to a temperature of no more than 300° C.
